(19) United States
(12) Patent Application Publication
(10) Pub. No.: US 2007/0057422 A1
(43) Pub. Date: Mar. 15, 2007

(54) Device for vibration-damping disposition of a unit, and unit equipped with such devices

(76) Inventors: Andreas Weh, Durach (DE); Michael Schlitzkus, Dietmannsried (DE); Matthias Mayr, Rettenberg (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 10/529,909

(22) PCT Filed: Sep. 29, 2003
(86) PCT No.: PCT/DE03/03231

§ 371 Date: Oct. 27, 2006

(30) Foreign Application Priority Data
Oct. 1, 2002 (DE) 102 45 797.2

(51) Int. Cl. F16F 7/00

(52) U.S. Cl. 267/141

(57) ABSTRACT

A vibration-damping device for mounting a unit on a mounting face, including a bell-shaped housing, a damping body of vibration-damping material disposed in the housing, a rigid core received in the damping body, and fastening means associated with both the core and the housing. The damping body is cup-shaped and offset in its outside diameter at least once jointly with the core, and the open end of the housing is closed with a closure whereby a positive engagement is established among the components. As a result, the device is capable of damping tensile and compressive forces on the unit equally. The damping devices can be disposed on a common outside area of the unit.

### PRIOR ART

The invention is based on a device defined by the preamble to claim 1 and on a unit equipped with such devices as generically defined by the preamble to claim 10. Such a device is already known from German Patent DE 39 41 401 C1. This known device, in FIG. 1, discloses the disposition of a hydraulic unit of an anti-lock brake system on the body of a motor vehicle, with the aid of a bracket and with the aid of devices of the generic type in question, acting as connections between the bracket and the hydraulic unit. These known devices include a bell-shaped housing that is open toward one end; a damping body of vibration-damping material, that is received in the housing; and a cylindrical core, connected to the hydraulic unit and supported in the damping body. The bell-shaped housing is secured to the bracket via a conventional, first fastening means in the form of a screw connection; a second fastening means forms a pin connection for fixation of the device to the hydraulic unit. For supporting the hydraulic unit, according to FIG. 2, a total of three such devices are provided, which are disposed on two opposed outsides of the hydraulic unit. The reason for this is that the individual devices are disadvantageously capable of absorbing or damping only forces on the hydraulic unit that act in one direction in space. For damping the forces acting in the opposite direction in space, two identical devices are therefore disposed opposite one another. This disposition, however, makes installation of the hydraulic unit in the vehicle more difficult. Another disadvantage is that the known device is not a structural unit that can be preassembled; its individual parts must instead be joined together in multiple operations. Because of the installation conditions in the vehicle, this assembly process can be time-consuming and hence expensive.

### ADVANTAGES OF THE INVENTION

The device of the invention having the characteristics of claim 1 has the advantage over the prior art that forces acting in opposite directions in space can be absorbed equally by a single device. As a result, the devices required for supporting a unit can be disposed on the same side of this unit, making its installation in the vehicle easier. Moreover, for most instances of use, two devices of the invention suffice. Furthermore, the devices can be preassembled and as a result can already be mounted on the hydraulic unit before the hydraulic unit is installed in the vehicle. A hydraulic unit prepared in advance in this way can be installed at the vehicle manufacturer with only a few manual operations; there is no need to put the devices together. Overall, not only is there economy in terms of individual parts, but the installation process is simplified considerably.

According to claim 4, it is especially advantageous if the fastening means provided for anchoring the device to the unit is a pin that can be press-fitted into a bore in the unit and is furthermore fixed to the housing of the unit. As a result, the force required for the press-fitting operation can be transmitted directly to the pin via the housing, so that the elastic damping body is not excessively pressed and does not suffer damage from the press-fitting operation.

The embodiment of the second fastening means in accordance with claim 5 as a hoop spring bent into a loop, with a spreader body disposed between the spring ends, makes it possible to fix the unit without tools, by positive engagement, given a suitably adapted embodiment of a bracket on the vehicle. By means of the characteristics of claim 7, the spreader body can be retained in captive fashion on the fastening means, so that there will be no excess components to be disposed of later.

Further advantages or advantageous refinements of the invention will become apparent from the other dependent claims or the ensuing description.

### DRAWINGS

The invention is shown in the drawing and described in further detail in the ensuing description.

Shown are:

FIG. 1, in a perspective view, a hydraulic unit of an anti-lock brake system, which is secured to a bracket on the vehicle via devices according to the invention;

FIG. 2, a first exemplary embodiment of the device according to the invention, in longitudinal section;

FIG. 3, also a longitudinal section, through a second exemplary embodiment of the invention;

FIG. 4, again in longitudinal section, a third exemplary embodiment of the invention; and

FIG. 5, an especially advantageous refinement of the invention.

### DESCRIPTION OF THE EXEMPLARY EMBODIMENTS

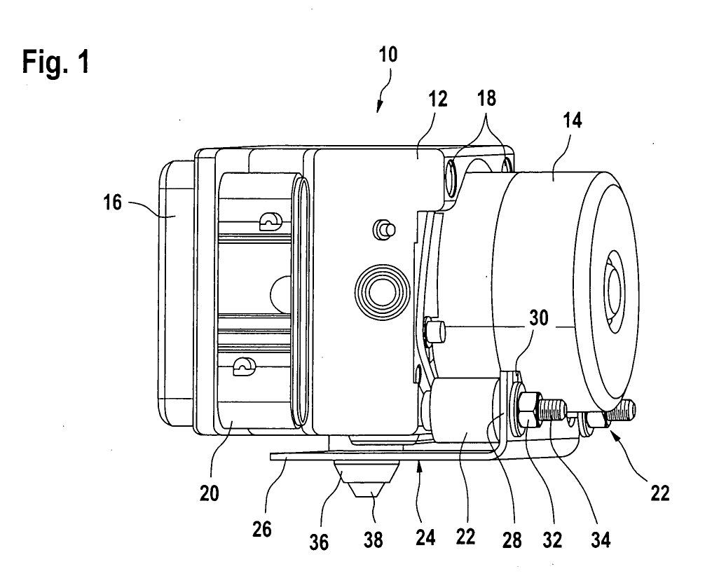

FIG. 1 shows a hydraulic unit 10 of an anti-lock brake system in perspective. This unit has a housing block 12, an electric motor 14, screwed to one face end of this housing block 12, and opposite the electric motor, an electronic control unit 16. Via a drive mechanism, supported in the interior of the housing 40 and not visible in FIG. 1, the electric motor 14 drives pump elements, also not visible, which build up a pressure in a hydraulic pressure fluid circuit. The pressure fluid is furnished to the hydraulic unit 10 via a master cylinder and a pressure fluid container connected to the master cylinder. The hydraulic connections 18 are used for furnishing the pressure fluid. The control unit 16 can be contacted electrically via an equipment plug 20 and serves to trigger hydraulic valves, also not visible, which are disposed in the housing block 12. These hydraulic valves control pressure fluid connections among conduits inside the housing block 12. Wheel brake cylinders can be connected to these conduits via brake lines. The hydraulic connections of the hydraulic unit 10 that are required for this are also provided on the housing block 12, but are again not visible in FIG. 1. The operation of the pump elements and the regulating events of the hydraulic valves can lead to pressure fluctuations in the hydraulic unit 10 which are transmitted to the body of a vehicle via the fastening of the hydraulic unit 10, and the vehicle passengers may perceive these as annoying.

To damp transmission of these pressure fluctuations to the vehicle body, the hydraulic unit 10 of FIG. 1 is secured via damping devices 22 of the invention to a bracket 24, it being assumed that this bracket 24 is anchored to the vehicle. A total of two damping devices 22 are present, which are fixed jointly to the same outside of the hydraulic unit 10 on which the electric motor 14 is also disposed. The bracket 24 on the vehicle body is embodied as an angle bracket 24, and it has a base plate 26, disposed at a slight spacing from the underside, opposite the connections 18, of the housing block 12 of the hydraulic unit 10 and mounts 28, bent essentially at a right angle in the direction of the electric motor 14. The mounts 28 form receptacles for the damping devices 22; they are disposed on both sides of the electric motor 14 and extend from the base plate 24 up to a level just below the center axis of the electric motor 14. The mounts 28 have two longitudinal slits 30, open at the top, into which a threaded pin 34 is placed which projects from the damping device 22 and is equipped with a nut 32. By means of this nut 32, the damping device 22 and the bracket 24 can be screwed together. The end of the damping device 22 of the invention located opposite the threaded pin 34 is connected to the housing block 12 of the hydraulic unit 10, preferably being press-fitted into place. Moreover, in the region below the housing block 12, a bracing element 36 of vibration-damping material is anchored to the base plate 26 of the bracket 24. This bracing element 36 is embodied annularly; it has an encompassing annular groove, open on the outside, which is not visible in the drawing and by way of which it is fixed in a suitably sized recess in the base plate 26. The hydraulic unit 10 rests on the portion of the bracing element 36 protruding from the recess and oriented toward the housing block 12, and to form a floating bearing, the hydraulic unit is provided with a protruding mandrel 38 that penetrates the bracing element 36.

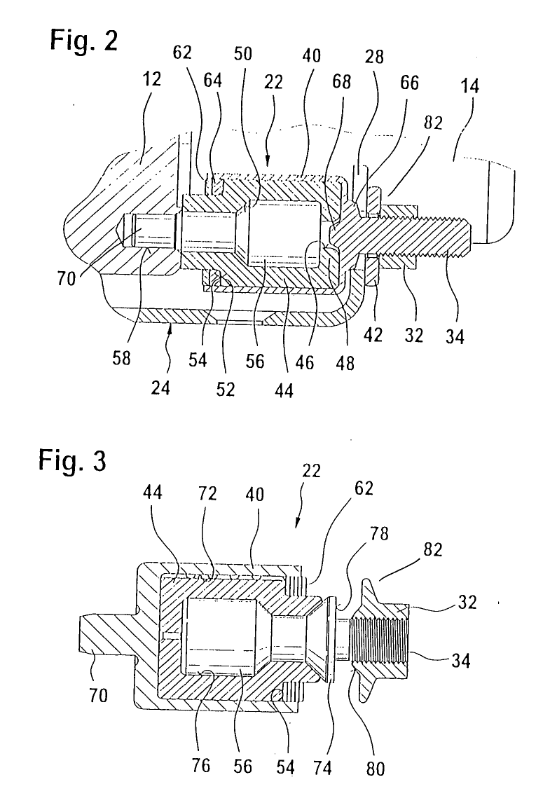

In FIG. 2, the damping device 22 of the invention is shown in longitudinal section, in one possible embodiment. This damping device 22 comprises a substantially bell-shaped housing 40, which is preferably made of metal. From the closed end of the housing 40, the threaded pin 34, on which the nut 32 is screwed, protrudes coaxially to the longitudinal axis of the housing. A shim 42 cooperates with the nut 32. A damping body 44 of vibration-damping material, such as elastomer, is received in the interior of the housing 40 of the damping device 22. Aside from a recess in its bottom, this damping body 44 is embodied in cup-shaped fashion. Its closed end rests on the closed end of the housing 40. In addition, the damping body 44 is offset once each in both its outer and inner diameters; the offset on the inner diameter is embodied as a cone, while that on the outer diameter is embodied as a right angle. The result is a perpendicular shoulder 54 on the outside of the damping body 44. A rigid core 56 of cylindrical cross section is received in the interior of the damping body 44, and its contour is adapted to the inner contour of the damping body 44. Accordingly, the core 56 is made up of one portion of larger outer diameter and one portion of smaller outer diameter; the transition between the two portions is also embodied conically. The portion of larger outer diameter is located on the end toward the closed end of the housing 40, while the smaller-diameter portion protrudes axially out of the open end of the housing 40 and with part of this protruding portion is press-fitted into a blind receiving bore 58, provided for it, in the housing block 12 of the hydraulic unit 10. The extent to which it is pressed in is determined, among other factors, by the length of a portion of the damping body 44 that has an offset outer diameter and likewise protrudes past the housing 40 of the damping device 22. The housing 40 of the damping device 22 is closed on its open end by a closure 60, which as an example is in the form of an annular disk 62, press-fitted into the interior of the housing 40, with a support disk 64 contacting the annular disk 62. Optionally, the support disk 64 can be dispensed with; alternatively, the closure 60 may also be embodied as crimping of the housing 40. In the present exemplary embodiment of FIG. 2, the closure 60 is secured far enough inside the housing 40 that its inner end face rests on the shoulder 54 of the damping body 44. Because of these conditions, the structural components comprising the housing 40, damping body 44 and core 56 are joined into a structural unit by positive engagement. Thus both tensile and compressive forces can be absorbed equally by a single damping device 22. The bottom of the housing 40 is provided at its center with a thickened portion 66, which is embodied in the direction of the housing interior as a peglike protrusion 68. This protrusion 68 engages a recess in the bottom of the damping body 44 and as a result establishes centering between the housing 40 and the damping body 44. When the damping device 22 of the invention is being press-fitted into the receiving bore 58 of the housing block 12 of the hydraulic unit 10, the press-fitting force is transmitted via the housing 40 to the core 56, whereupon the damping body 44 deforms elastically to such an extent that the play that exists between the protrusion 68 in the bottom of the housing 40 and the core 56 is consumed, and the protrusion 68 now rests directly on the core 56. The existing play is selected such that the damping body 44 suffers no damage from the press-fitting operation. On the side remote from this protrusion 68, the thickened portion 66 of the housing bottom forms a cone. By way of it, centering of the damping device 22 in the longitudinal slit 30 in the bracket 24 of FIG. 1 is effected, as soon as the hydraulic unit 10 is screwed to this bracket 24 via the nut 32.

FIG. 3, likewise in longitudinal section, shows a refinement of the damping device 22 of the invention. This refined damping device 22 again comprises a bell-shaped housing 40, a damping body 44 disposed in this housing, and a core 56 received by the damping body 44. The various fastening means 82 are again associated with the housing 40 and to the core 56, but unlike the exemplary embodiment of FIG. 2, the pin 70 is now disposed on the housing 40, and the threaded pin 34 is now disposed on the core 56. By this transposition in the disposition of the fastening means 82, the press-fitting force required for press-fitting the damping device 22 is transmitted directly to the protruding pin 70 via the housing 40, so that no deformation of the damping body 44 occurs. This precludes damage to the damping body 44. Other distinctions from the exemplary embodiment of FIG. 2 in this damping device 22 are that the housing 40, on its inner wall toward the damping body 44, is provided with a surface structure 72, such as knurling. Also or alternatively, the core 56 and/or the damping body (44) itself may be provided, on their circumferential surfaces oriented toward one another, with an arbitrary surface structure 72. These provisions improve the positive engagement among the core 56, the damping body 44 and the housing 40, and as a result the torque between the nut 32 and the threaded pin 34 can be increased without causing a relative motion among these components. Because of this, a well-known self-securing nut, which because of its greater tightening torque assures additional security against unintended loosening, can be used as the nut 32. Another distinction is that the core 56, on its side toward the nut 32, is provided with a second widening 74 in diameter, which is spaced apart in the direction of the longitudinal axis from the first widening 76 in diameter. The second widening 74 in diameter is likewise beveled conically on its side toward the first widening 76 in diameter but is offset at a right angle on its side away from it. A resultant shoulder 78, in the installed state of the hydraulic unit 10, rests two-dimensionally on the mount 28 on the side remote from the nut 32. For centering the damping device 22 on the longitudinal slit 30 in the mount 28 (FIG. 2), a centering cone 80 mounted on the nut 32 toward the mount is now used. The housing 40 of the damping device 22 has a bottom without a thickened portion 66, and as a result, it can be produced more economically than in the exemplary embodiment of FIG. 2.

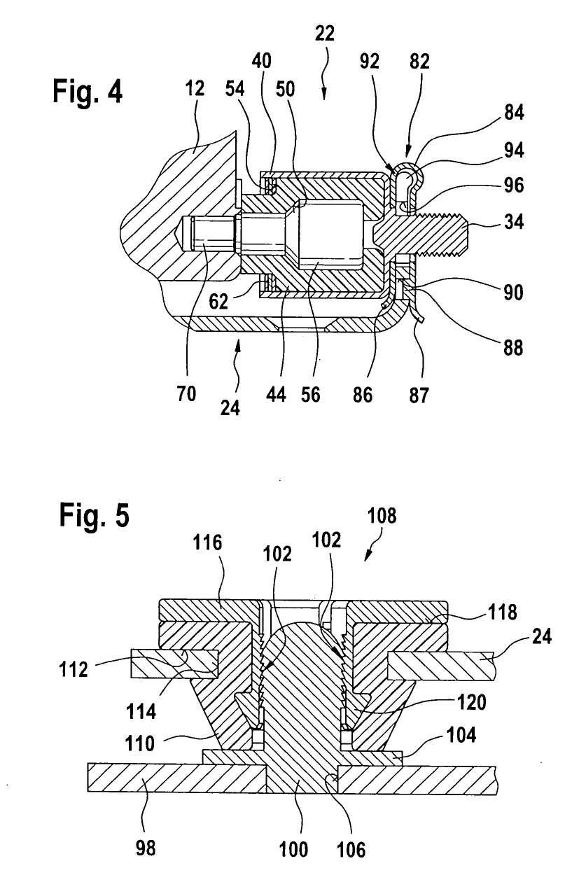

The exemplary embodiment of FIG. 4 is an especially advantageous embodiment for the fastening means 82 that cooperates with the mount 28 of the bracket 24. This fastening means 82 enables anchoring of the hydraulic unit 10 to the bracket 24 by positive engagement, without the use of tools. The operation of installing the hydraulic unit 10 in the vehicle is still further simplified as a result. For this purpose, instead of the nut 32 used in the exemplary embodiments described above, a hoop spring 84 is provided, which is a spring element bent into an open loop, with two spring ends 86, 87 that can be prestressed counter to one another. The spring end 86 oriented toward the hydraulic unit 10 is anchored to the housing 40 of the damping device 22, while the second spring end 87, remote from it, is relatively movable with respect to this first spring end 86. This relatively movable spring end 87 is provided on the inside, in the region of its open end, with a protruding fixation lug 88, which in the installed state of the hydraulic unit 10 engages a corresponding recess in the mount 28 of the bracket 24. For mounting [“installed” in previous sentence, “mounting” here—both seem appropriate] the hydraulic unit 10 on the bracket 24, the mount 28 of the bracket is thrust between the two spring ends 86 until the fixation lug 88 snaps into place. To make it at all possible to introduce the mount 28 between the spring ends 86, these spring ends 86, 87 of the hoop spring 84 are spread apart, in their non-mounted state, by an elongated spreader element 92. The extent of spreading is determined by the thickened head 94 of the spreader element 92, which is oriented toward the closed end of the hoop spring 84 and is sized somewhat larger than the thickness of the material comprising the mount 28. Upon the introduction of the mount 28 into the open end of the hoop spring 84, the spreader element 92 is displaced inward between the two spring ends 86 in the direction of the closed end of the hoop spring 84, until finally the head 94 of the spreader element 92 enters the region of the bending radius of the hoop spring 84. This bending radius receives the entire head 94 of the spreader element 92, so that the fastening means 84 snaps closed. Both the spreader element 92 and both spring ends 86 and 87 of the hoop spring 84 are provided with continuous elongated recesses 96. The pin 34 embodied on the housing 40 of the damping device 22 protrudes through these recesses, so that even after the hydraulic unit 10 has been secured to the bracket 24, the spreader element 92 is retained in captive fashion. The pin 34 of this exemplary embodiment is embodied as a threaded pin, for example, which affords the various vehicle manufacturers the option of fastening not only by purely positive engagement, as described above, but also by purely nonpositive engagement, with the aid of a nut 32 screwed onto the threaded pin, as well as the possibility of combining these two options.

A further possibility for anchoring a hydraulic unit 10 to the body of a motor vehicle is shown in FIG. 5. This FIG. 5 shows an armature plate 98 with a stay bolt 100, in this example fixed to it, that protrudes at a right angle. The stay bolt has a cylindrical cross section and a free end that is rounded in domelike fashion, and along its circumference it is provided with a plurality of axially spaced-apart, encompassing detent hooks 102 of conical form. With an integrally formed-on annular collar 104 in the region of the second end, opposite the domelike end, the stay bolt 100 is braced on the armature plate 98. The armature plate 98 is provided with recesses 106, into which the stay bolts 100 are inserted in portions. The armature plate 98 embodied in this way is mounted at the intended mounting site for the hydraulic unit 10 by the vehicle manufacturer; it is assumed that the hydraulic unit 10, explicitly not shown in FIG. 5, is secured to the bracket 24 by means of the damping devices 22 described above. The bracket is shown in only fragmentary form in FIG. 5 and is equipped with detent elements 108, which cooperate with the stay bolts 100. These detent elements 108 comprise a damping ring 110 of vibration-damping material, such as elastomer, and they have an encompassing annular groove 112 open on the outside. The annular groove 112 is adapted in terms of its groove width to the wall thickness of the bracket 24; moreover, the groove bottom is essentially equivalent to the diameter of a continuous recess in the bracket 24, so that the damping rings 110 can be fixed both radially and axially in the recess via this annular groove 112. A retaining bush 116 is moreover inserted into the opening in a damping ring 110. On one of its ends, the retaining bush 116 has an encompassing collar 118, which rests two-dimensionally on an end face of the damping ring 110. On the end of the retaining bush 116 opposite the collar 118, a radially outward-protruding detent hook 120, embodied conically in the direction opposite the installation direction, is formed integrally on and engages a corresponding undercut on the inside of the damping ring 110. Compared to the damping ring 110, the retaining bush 116 is a relatively rigid component, so that once the retaining bush is mounted in this damping ring 110, the detent element 108 is reliably anchored to the bracket 24. Furthermore, the retaining bush 116 is also provided on its inside with axially successive detent hooks 102, of identical geometry to the detent hooks 102 of the stay bolts 100 but oriented oppositely. As a result, the stay bolts 100 and detent elements 108 can be put together and fixed relative to one another by relatively slight force exerted in the longitudinal direction of the stay bolts 100. They thus make a reliable positive engagement possible between the bracket 24, equipped with the hydraulic unit 10, and the armature plate 98, mounted on the vehicle. In the final position of the plug connection described, the damping ring 110 rests with its end opposite the stop 118 on the annular collar 104 of the stay bolts 100. Because of the damping device 22 of the invention, with its damping body 44, and the damping ring 110 in the detent element 108, the hydraulic unit 10 is effectively decoupled in terms of vibration from the body of a motor vehicle. Possible vibration caused by an actuation of the pump elements and/or by the triggering of the magnet valves of the hydraulic unit 10 is effectively damped as a result and thus is hardly perceptible as operating noise to the vehicle passengers any longer. For removal of the hydraulic unit 10, for instance for servicing, the connection between the damping devices 22, described above and fixed on the hydraulic unit 10, and the bracket 24 is undone.

It is understood that changes or additions may be made to the exemplary embodiments described without departing from the fundamental concept of the invention. In this respect, it should be noted that for the sake of better mounting of the rigid core 56, the damping body 44 of the damping device 22 may also be embodied as slit in its longitudinal direction.

1-13. (canceled)

14. A vibration-damping device (10) for mounting a hydraulic unit of a brake system on a mounting face of a body of a motor vehicle, the vibration-damping device comprising,
a substantially bell-shaped housing (40), having a closed end
a damping body (44) of vibration-damping material disposed in the interior of the housing (40),
a core (56) supported in the damping body (44),
fastening means (82) associated with the core (56) and with the housing (40), the damping body (44) being substantially cup-shaped and having a substantially closed end and a contour that is offset at least once in both the outer diameter and the inner diameter, the substantially closed end of the damping body (44) resting on the closed end of the housing (40);
the core (56) being adapted to fit within the cup-shaped contour of the damping body (44) and being offset at least once in its outer diameter to produce larger and smaller diameter portions at its opposed ends and an annular shoulder (54) therebetween, with the larger diameter and portion of the core (56) oriented toward the closed end of the housing (40);
a closure (62) on the open end of the housing (40) resting on the shoulder (54).

15. The device of claim 14, wherein the closure (62) is formed by a crimping of the housing (40).

16. The device of claim 14, wherein the closure (62) includes an annular disk (62) secured in the region of the open end of the housing (40).

17. The device of claim 14, wherein the fastening means (82) comprises first fastening means (82), including a pin (70) for anchoring the vibration damping device (22) to the unit (10), which pin (70) can be press-fitted into an associated bore of the unit (10) and which is associated with the bell-shaped housing (40) of the vibration damping device (22).

18. The device of claim 15, wherein the fastening means (82) comprises first fastening means (82), including a pin (70) for anchoring the vibration damping device (22) to the unit (10), which pin (70) can be press-fitted into an associated bore of the unit (10) and which is associated with the bell-shaped housing (40) of the vibration damping device (22).

19. The device of claim 16, wherein the fastening means (82) comprises first fastening means (82), including a pin (70) for anchoring the vibration damping device (22) to the unit (10), which pin (70) can be press-fitted into an associated bore of the unit (10) and which is associated with the bell-shaped housing (40) of the vibration damping device (22).

20. The device of claim 14, wherein the fastening means (82) comprises second fastening means (82) including a hoop spring (84) for anchoring the unit (10) to the mounting face, the hoop spring (84) being bent into an open loop with two spring ends (86, 87) that can be prestressed against one another, one of the spring ends (86) being anchored to the vibration-damping device (22) and the second spring end (87) being movable relative to this first spring end (86).

21. The device of claim 17, wherein the fastening means (82) comprises second fastening means (82) including a hoop spring (84) for anchoring the unit (10) to the mounting face the hoop spring (84) being bent into an open loop with two spring ends (86, 87) that can be prestressed against one another, one of the spring ends (86) being anchored to the vibration-damping device (22) and the second spring end (87) being movable relative to this first spring end (86).

22. The device of claim 20, wherein the second spring end (87) has an inward-protruding fixation lug (88); and wherein a spreader body (92) which in its basic position spreads the spring ends (86, 87) is displaceably disposed between the two spring ends (86, 87).

23. The device of claim 21, wherein the second spring end (87) has an inward-protruding fixation lug (88); and wherein a spreader body (92) which in its basic position spreads the spring ends (86, 87) is displaceably disposed between the two spring ends (86, 87).

24. The device of claim 22, wherein the spreader body (92) and the spring ends (86, 87) of the hoop spring (84) are provided with continuous recesses (96), through which a pin (34) projecting axially from the housing (40) protrudes.

25. The device of claim 23, wherein the spreader body (92) and the spring ends (86, 87) of the hoop spring (84) are provided with continuous recesses (96), through which a pin (34) projecting axially from the housing (40) protrudes.

26. The device of claim 14, wherein the damping body (44) of the vibration-damping damping device (22) is slit along its longitudinal axis.

27. The device of claim 14, wherein the housing (40) and/or the core (56) and/or the damping body (44) are provided with a surface texture (72), such as knurling, on their faces oriented toward one another.

28. The device of claim 15, wherein the housing (40) and/or the core (56) and/or the damping body (44) are provided with a surface texture (72), such as knurling, on their faces oriented toward one another.

29. A hydraulic unit (10) of an anti-lock brake system having a housing block (12), and vibration-damping devices (22) of claim 14 fixed to this housing block (12), characterized in that the devices (22) are fixed on a common outside area of the unit (10).

30. The unit of claim 29, wherein the unit (10) is anchored to a mounting face indirectly via an angle bracket (24) equipped with a base plate (26) and with mounts (28), projecting substantially perpendicularly toward the base plate (26), for securing the vibration-damping devices (22).

31. The unit of claim 30, further comprising at least one vibration-damping bracing element (36) disposed on the base plate (26), axially spaced apart from the vibration-damping devices (22), with the unit (10) resting on this bracing element, the bracing element (36) having the form of a ring retained in a continuous recess in the base plate (26) by means of an encompassing groove open on the outside, the unit (10), on its side toward the base plate (26), having a mandrel (38), which at least partly penetrates this ring.

32. The unit of claim 30, wherein the mounting face is formed by an armature plate (98) equipped with stay bolts (100); wherein the bracket (24) has detent elements (108), associated with the stay bolts (100) of the armature plate (98), these detent elements (108) including vibration-damping damping rings (110) that are insertable into bores in the bracket (24) and also including retaining bushes (116) retained in the damping rings (110) by positive engagement; and wherein the stay bolts (100) and the retaining bushes (116) can be interlocked with one another.

33. The unit of claim 31, wherein the mounting face is formed by an armature plate (98) equipped with stay bolts (100); wherein the bracket (24) has detent elements (108), associated with the stay bolts (100) of the armature plate (98), these detent elements (108) including vibration-damping damping rings (110) that are insertable into bores in the bracket (24) and also including retaining bushes (116) retained in the damping rings (110) by positive engagement; and wherein the stay bolts (100) and the retaining bushes (116) can be interlocked with one another.
